(19) United States
(12) Patent Application Publication
(10) Pub. No.: US 2025/0262628 A1
(43) Pub. Date: Aug. 21, 2025

(54) Water switching structure of gardening water sprayer

(71) Applicant: SHIN TAI SPURT WATER OF THE GARDEN TOOLS CO., LTD., Changhua County (TW)

(72) Inventor: Chin-Yuan Chen, Changhua County (TW)

(73) Assignee: SHIN TAI SPURT WATER OF THE GARDEN TOOLS CO., LTD., Changhua County (TW)

(21) Appl. No.: 18/582,073

(22) Filed: Feb. 20, 2024

(51) Int. Cl. B05B 1/16; B05B 12/00; B05B 15/63

(52) U.S. Cl. CPC B05B 1/1645; B05B 1/169; B05B 12/002; B05B 15/63

(57) ABSTRACT

A water switching structure of a gardening water sprayer includes a water sprayer body and a water spray head. The water sprayer body has a grip part and a barrel part. The barrel part is designed in a polygonal shape so that multiple reference planes and multiple reference lines are formed on the outer periphery of the barrel part. The reference line is used to provide a connection between two adjacent reference planes so that the reference plane and the reference line can be staggered on the barrel part. The end ring of the water spray head is provided with a plurality of spray holes that can spray different water spray shapes, and the water spray head is designed in a polygonal shape. A plurality of calibration plane and a plurality of calibration lines are formed staggered around the outer circumference of the water spray head.

### BACKGROUND OF THE INVENTION

### Field of the Invention

The present invention relates to a gardening water sprayer, and in particular, to a gardening water sprayer with a water outlet switching structure that switches the shape of water splashes through rotation.

### Description of the Related Art

As shown in FIG. 7, The conventional water sprayer 30 mainly has a sprayer body 31, the inside of the sprayer body 31 is provided with a flow channel, and the front end is provided with a rotatable water spray head 32 having a plurality of water spray holes formed on. By aligning one of the water spray holes to the flow channel, the water fed to the sprayer body 31 can pass through the flow channel and then spray out from the water spray hole. When the water spray head 32 is turned, the shape of these water spray holes can also be changed to achieve changes of the water splash shapes. The common water sprayer 30 will be marked on the sprayer body 31 and the water spray head 32, so that the user can use the icon 33 (the icon 33 can be symbols, patterns, texts, or arrows) for alignment to allow the water spray holes to accurately connect to the flow channels to achieve relatively smooth water spray.

However, the conventional structure as mentioned above still has the following problems in practical application. First, the icon 33 is set through printing, spray painting, etc., or is a shallow scratch, and is easily worn away due to contact during use. This relative position cannot continue to provide alignment during subsequent use. If the water sprayer 30 cannot be accurately aligned, it will cause the water sprayer 30 to fail to spray water. Second, the icons 33 need to be stared at all the time when aligning, and the alignment cannot be completed by just touching (feeling) of the hands, so the convenience of use is not good. Third, the icon 33 is small and is relatively difficult to provide alignment.

### SUMMARY OF THE INVENTION

The technical issue to be resolved by the invention is that the icons used for identification of the water sprayer are small and easily worn off.

The invention provides a water switching structure of a gardening water sprayer including a water sprayer body and a water spray head. The water sprayer body has a grip part and a barrel part, the grip part is provided with a water inlet end, the barrel part is provided with a water outlet end, and the water inlet end and the water outlet end are connected by a flow channel, the water source sent from the water inlet end into the interior of the water sprayer body can pass through the flow channel to the water outlet end. The barrel part is designed in a polygonal shape so that multiple reference planes and multiple reference lines are formed on the outer periphery of the barrel part. The reference line is used to provide a connection between two adjacent reference planes so that the reference plane and the reference line can be staggered on the barrel part. The end ring of the water spray head is provided with a plurality of spray holes that can spray different water spray shapes, and the water spray head is designed in a polygonal shape. A plurality of calibration plane and a plurality of calibration lines are formed staggered around the outer circumference of the water spray head, and the calibration plane and the reference plane are all aligned with the spray head. The spray holes are provided with the same number of the calibration plane and the reference plane so that each of the calibration plane can be aligned with one of the spray holes. The water spray head is pivoted on the water outlet end of the water sprayer body, which is provided with any of the calibration plane through a reference plane for alignment during use to identify whether the spray hole is accurately connected to the flow channel. The contact surface of the reference plane and the calibration plane provides a large area and the alignment can be completed simply by the touch of the hand. By using the reference line and the calibration line, the alignment also has the same recognition effect.

Compared to the conventional structure, the invention has several benefits. This invention provides a water switching structure of a gardening water sprayer. When it is used, the rotation of the water spray head is used to switch the spray holes with different water spray shapes. During the rotation process, the reference plane can also be used to provide any calibration plane for alignment to complete the identification of whether the spray hole is accurately connected to the flow channel. When the spray hole is accurately connected to the flow channel, water can be sprayed smoothly, and since the reference plane and the calibration plane are designed to be in a single plane, the alignment is relatively simple and there is no need to worry that the reference plane and the calibration plane will be worn away due to contact during use. When holding and turning a large area, there is no need to stare at it and the alignment can be completed by just the touching of the hand. Because the barrel part and the water spray head do not need to be printed, spray-painted, or scored to set icons, this invention makes the manufacturing process of the switching structure of the gardening water sprayer further simplified, thereby effectively reducing the production cost.

### BRIEF DESCRIPTION OF THE DRAWINGS

The following drawings are merely examples for illustrative purposes according to various disclosed embodiments and are not intended to limit the scope of the present disclosure.

FIG. 1 is a three-dimensional combination diagram of this invention.

FIG. 2 is a three-dimensional exploded view of this invention.

FIG. 3 is the combined plan view of this invention.

FIG. 4 is a diagram of the rotating status of the spray head of this invention.

FIG. 5 is another diagram of the rotating status of the spray head from another viewing angle of this invention.

FIG. 6 is a diagram of the alignment state of the spray head after rotation.

FIG. 7 is a structure diagram of the prior art.

### DETAILED DESCRIPTION OF THE INVENTION

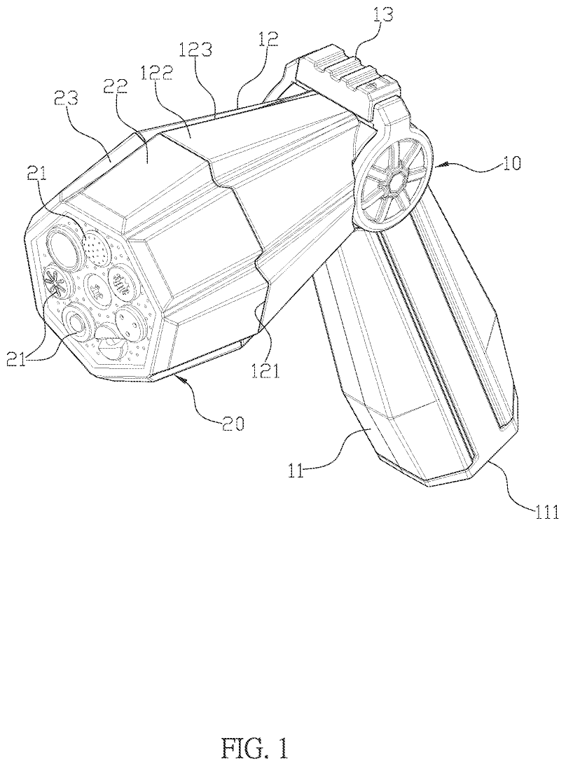

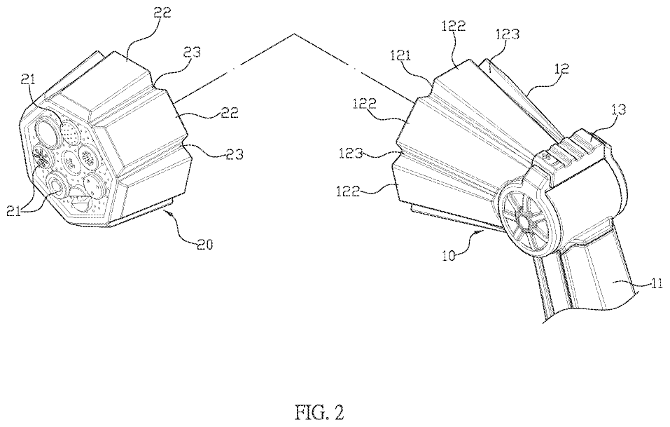

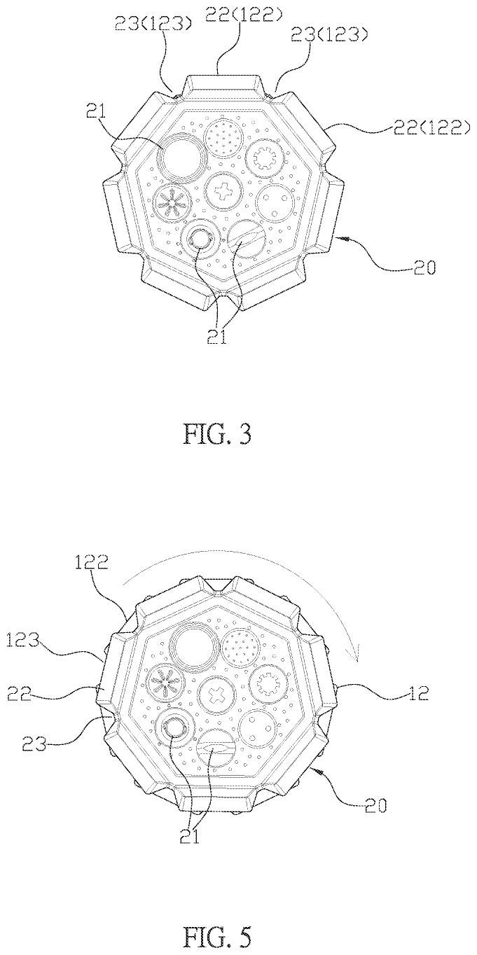

First, as shown in FIGS. 1-3, a water switching structure of a gardening water sprayer includes a water sprayer body 10 and a water spray head 20. The water sprayer body 10 has a grip part 11 and a barrel part 12, the grip part 11 is provided with a water inlet end 111, the barrel part 12 is provided with a water outlet end 121, and the water inlet end 111 and the water outlet end 121 are connected by a flow channel, the water source sent from the water inlet end 111 into the interior of the water sprayer body 10 can pass through the flow channel to the water outlet end 121. The barrel part 12 is designed in a polygonal shape, so that multiple reference planes 122 and multiple reference lines 123 are formed on the outer periphery of the barrel part 12. The reference line 123 is used to provide a connection between two adjacent reference planes 122 so that the reference plane 122 and the reference line 123 can be staggered on the barrel part 12. The end ring of the water spray head 20 is provided with a plurality of spray holes 21 that can spray different water spray shapes, and the water spray head 20 is designed in a polygonal shape. A plurality of calibration plane 22 and a plurality of calibration lines 23 are formed staggered around the outer circumference of the water spray head 20, and the calibration plane 22 and the reference plane 122 are all aligned with the spray head 20. The spray holes 21 are provided with the same number of the calibration plane 22 and the reference plane 122 so that each of the calibration plane 22 can be aligned with one of the spray holes 21. The water spray head 20 is pivoted on the water outlet end 121 of the water sprayer body 10, which is provided with any of the calibration plane 22 through a reference plane 122 for alignment during use to complete the spraying process to identify whether the spray hole 21 is accurately connected to the flow channel. The contact surface of the reference plane 122 and the calibration plane 22 provides a large area and the alignment can be completed simply by the touch of the hand. By using the reference line 123 and the calibration line, the alignment also has the same recognition effect.

The present invention provides a water switching structure of a gardening water sprayer, wherein the barrel part 12 and the water spray head 20 are set in a regular heptagonal shape, so that the barrel part 12 can have seven reference planes 122, and the water spray head 20 has seven calibration plane 22.

This invention provides a water switching structure of a gardening water sprayer, wherein the reference plane 122 and the calibration plane 22 are both in the shape of a slope that gradually rises toward one end.

The present invention provides a water switching structure of a gardening water sprayer, wherein the reference line 123 and the calibration line 23 are both concave portions, so that the concave portion can increase a coverage range of the reference line 123 and the calibration line 23.

The invention provides a water switching structure of a gardening water sprayer, wherein the reference line 123 and the calibration line 23 are both concave V-shaped grooves, so that the V-shaped grooves can increase the coverage range of the reference line 123 and the calibration line 23.

The invention provides a water switching structure of a gardening water sprayer, wherein the water sprayer body 10 is provided with a finger-controlled valve 13, so that the finger-controlled valve 13 can control a spray size.

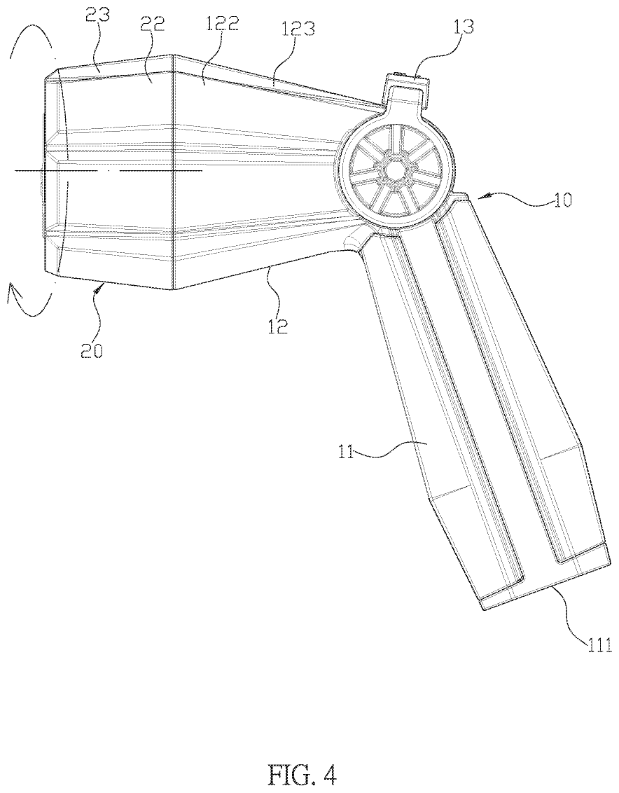

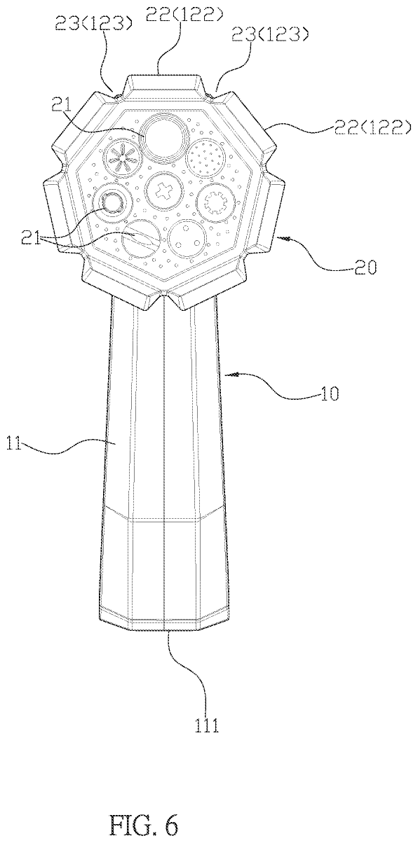

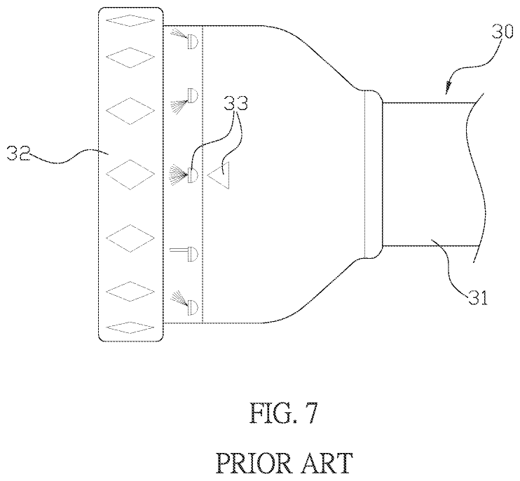

As shown in FIGS. 4-6, when it is used, the rotation of the water spray head 20 is used to switch the spray holes 21 with different water spray shapes. During the rotation process, the reference plane 122 can also be used to provide any calibration plane 22 for alignment to complete the identification of whether the spray hole 21 is accurately connected to the flow channel. When the spray hole 21 is accurately connected to the flow channel, water can be sprayed smoothly, and since the reference plane 122 and the calibration plane 22 are designed to be in a single plane, the alignment is relatively simple and there is no need to worry that the reference plane 122 and the calibration plane 22 will be worn away due to contact during use. When holding and turning a large area, there is no need to stare at it and the alignment can be completed by just the touching of the hand. Because the barrel part 12 and the water spray head 20 do not need to be printed, spray-painted, or scored to set icons, this invention makes the manufacturing process of the switching structure of the gardening water sprayer further simplified, thereby effectively reducing the production cost.

What is claimed is:

1. A water switching structure of a gardening water sprayer comprising a water sprayer body and a water spray head, wherein:
the water sprayer body has a grip part and a barrel part, the grip part is provided with a water inlet end, the barrel part is provided with a water outlet end, the water inlet end and the water outlet end are connected by a flow channel, the water source sent from the water inlet end into the interior of the water sprayer body can pass through the flow channel to the water outlet end, the barrel part is designed in a polygonal shape so that multiple reference planes and multiple reference lines are formed on the outer periphery of the barrel part, the reference line is used to provide a connection between two adjacent reference planes so that the reference plane and the reference line can be staggered on the barrel part; and
a end ring of the water spray head is provided with a plurality of spray holes that can spray different water spray shapes, the water spray head is designed in a polygonal shape, a plurality of calibration plane and a plurality of calibration lines are formed staggered around an outer circumference of the water spray head, the calibration plane and the reference plane are all aligned with the spray head, the spray holes are provided with the same number of the calibration plane and the reference plane so that each of the calibration plane can be aligned with one of the spray holes, the water spray head is pivoted on the water outlet end of the water sprayer body, which is provided with any of the calibration plane through a reference plane for alignment during use to identify whether the spray hole is accurately connected to the flow channel, the contact surface of the reference plane and the calibration plane provides a large area and the alignment can be completed simply by the touch of the hand, by using the reference line and the calibration line, the alignment has a recognition effect.

2. The water switching structure of the gardening water sprayer of claim 1,
wherein the reference line and the calibration line are both concave portions, so that the concave portions can increase a coverage range of the reference line and the calibration line.

3. The water switching structure of the gardening water sprayer of claim 1,
wherein the reference line and the calibration line are both concave V-shaped grooves, so that the V-shaped grooves can increase the coverage range of the reference line and the calibration line.

4. The water switching structure of the gardening water sprayer of claim 1,
wherein the water sprayer body is provided with a finger-controlled valve, so that the finger-controlled valve can control a spray size.
